(19) United States
(12) Patent Application Publication
(10) Pub. No.: US 2006/0141417 A1
(43) Pub. Date: Jun. 29, 2006

(54) Method for making surgical guiding sleeves components for a surgical template

(76) Inventors: Dov M. Almog, Pittsford, NY (US); John Gresty, Rochester, NY (US)

Correspondence Address: Dov M. Almog, 8 Tumberry Lane, Pittsford, NY, 14534, US

(21) Appl. No.: 11/024,186

(22) Filed: Dec. 28, 2004

(51) Int. Cl. A61C 3/02; A61C 8/00

(52) U.S. Cl. 433/76

(57) ABSTRACT

Current dental implant guide sleeve systems for orienting a drill bit in the pre-determined location and angulation for making an implant osteotomy in the recipient's mouth are complicated and/or require multiple custom-made surgical templates in order to accommodate different osteotomy drills' diameters. The novel “thread-lock” invention system is based on the use of a master bushing which is inserted into a predetermined location and hole and secured by means of an adhesive to custom-made surgical template. Its inner diameter is tapped through 8×32 and reamed out to suit the largest diameter drill being used. The smaller sleeves screw into the primary sleeve and are locked into place with a clockwise twisting motion. The smaller sleeves are tapped through 8×32 and reamed out to suit the subsequent diameter sleeves used. The result is that multiple bushings with different diameter holes can be assembled on one surgical template and that three different diameter holes, starting from the smallest diameter and moving up, can be drilled on the same precise location and trajectory.

### BACKGROUND OF THE INVENTION

Accomplishing predictable reconstruction and aesthetic results for single or multiple tooth replacement with dental implants is challenging. Historically, residual bone height observed on panoramic radiographs and residual bone trajectory (RBT) or angulation observed during surgery determined implant size and trajectory, at times compromising anatomical, mechanical and aesthetic needs. The final trajectory of an implant, especially in a buccal-lingual direction, does not always conform to that of the natural tooth or the planned prosthetic trajectory (PPT). This may be primarily due to buccal bone loss in the first one to three years following tooth loss.

While no evidence has yet been established, probably one of the most common problems encountered in treating the dental implant patient is the lack of adequate treatment planning. This is most often an issue when implants are placed in aesthetic zones that require precise consideration for tooth position requirements. Examination of study casts, anesthetizing and probing the depth of the mucosa over the bone and the use of panoramic and lateral skull radiographs are methods frequently used to determine the adequacy of bone. A number of previous reports documented that optimum, and at times critical, implant size and orientation can be aided by a cross-sectional, three-dimensional radiographic exam. Moreover, in a recent position paper, the AAOMR recommended that some form of cross-sectional imaging be used for implant cases and preferably with a radiopaque planned/ideal trajectory indicator.

While the tomogram revealed the outline of the bone, its width and height, only the use of the radiopaque indicator illustrated the bone to implant and bone to PPT correlation. Although the numerical relationship between dental implant treatment success or failure and cross-sectional imaging used in conjunction with and without imaging guides is unknown and awaits prospective trials Several different types of imaging guides were introduced and used, consisting of different radiopaque indicators, which the patient wore during the cross-sectional exam, enabling clinicians to transfer the information obtained from the imaging phase to both the surgical and restorative phases of treatment.

Once the specific location and trajectory of each implant is determined, the specific intend of this invention is to provide with a simplified guiding sleeves system for orienting a drill bit in the pre-desired location and angulation for making an implant osteotomy in the recipient's mouth. Current guide sleeve systems are complicated and/or require multiple custom-made surgical templates in order to accommodate different osteotomy drills' diameters.

### BRIEF SUMMARY OF THE INVENTION

The guiding sleeves system is a novel method for manufacturing guiding sleeves for orienting a drill bit in a desired location and angulation for making an implant osteotomy.

One embodiment of the present invention is directed towards the unique “thread-lock” system, accommodating different size holes for different size drills using multiple bushings.

Second embodiment of the present invention is directed towards precisely guiding the placement of dental implants at a predetermined location and angulation/trajectory.

For a further understanding of the nature and advantages of the present invention, reference should be made to the following description in conjunction with the accompanying FIGS. 1-3.

### BRIEF DESCRIPTION OF THE FIGURES

FIG. 1 is a partial view of a computer manufactured surgical template with pre-fabricated/planned holes for placing a metal guide sleeve. It demonstrated the assembling of the master or primary bushing, with a 3.5 mm diameter hole, in accordance with an embodiment of the present invention, which is inserted into a predetermined hole and secured by means of an adhesive.

FIG. 2 is demonstrating the threading of the secondary smaller bushing, with a 2.9 mm diameter hole, which is screwed into the primary sleeve and locked into place with a clockwise twisting motion.

FIG. 3 is demonstrating the assembling of the third smaller bushing, with a 2.35 mm diameter hole, which is screwed into the primary sleeve (after removal of the secondary sleeve) and locked into place with a clockwise twisting motion. The result is that multiple bushings with different diameter holes can be assembled on one surgical template.

### DETAILED DESCRIPTION OF THE INVENTION

Embodiments of the present invention provide a method for making a guiding sleeves system for orienting a drill bit in a desired location and angulation for making an implant osteotomy. Embodiments of the guiding sleeves system work in conjunction with a pre-custom-made surgical template fitting the recipient's mouth. These pre-custom-made surgical templates are computer manufactured, machined or hand-made, and are custom-made for use in a dental implant recipient's mouth.

Assembling of the master or primary bushing with the largest diameter hole, in accordance with the embodiment of the present invention, involves the insertion of the bushing into a predetermined hole and secured by means of an adhesive.

The main embodiment of the present invention is directed towards the novel “thread-lock” system that facilitates the drilling of the osteotomy. This specific embodiment lowers the cost of the procedure drastically by enabling one pre-custom-made surgical template to accommodate different size holes for different size drills using multiple bushings, located in the same precise location and trajectory, all in accordance with an embodiment of the present invention.

The novel “thread-lock” system is based on the use of a master or primary bushing which is inserted into a predetermined hole and secured by means of an adhesive to the pre-custom-made surgical template. Its inner diameter is tapped through 8×32 and reamed out to suit the largest diameter drill being used. The smaller sleeves screw into the primary sleeve and are locked into place. The smaller sleeves are screw-cut to suit the primary bushing and reamed out to suit the subsequent diameter sleeves used. The result is that multiple different diameter holes, starting from the smallest diameter to drill the initial pilot osteotomy and moving up to the desired diameter, can be drilled in the same precise location and trajectory.

A secondary embodiment of the present invention is directed towards precisely guiding the placement of dental implants at a predetermined location and angulation/trajectory, avoiding the violation of anatomical landmarks in the area corresponding location of the said dental implant.

The guiding sleeves system according to embodiments of the present invention, when used in conjuncture with a routine dental implant placement procedure, can have a widespread impact and will improve, facilitate and lower the cost of the dental implant delivery process.

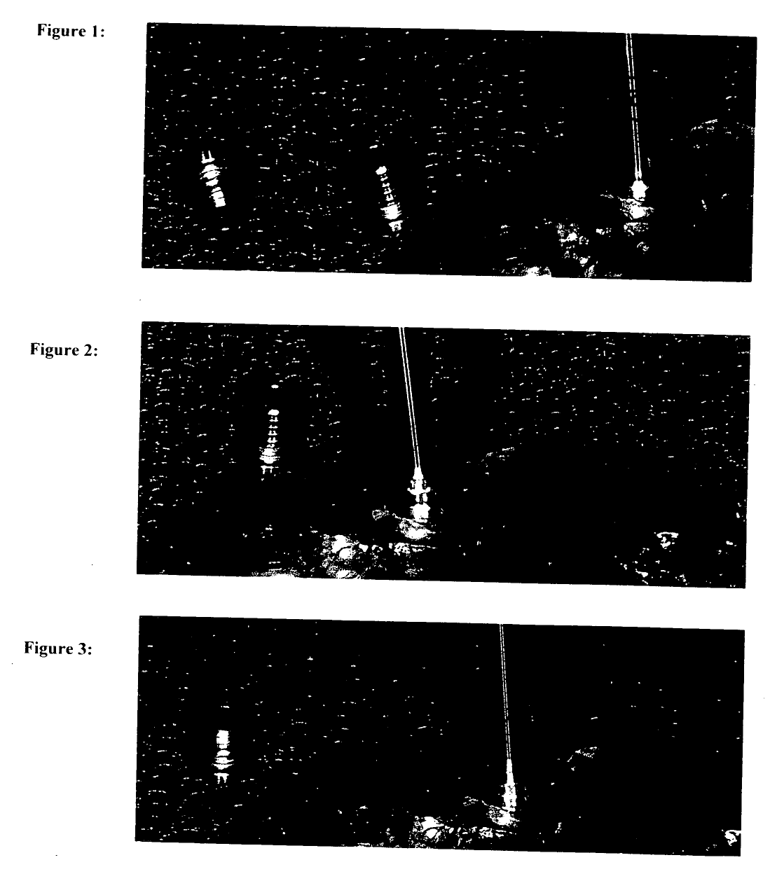

For a further understanding of the nature and advantages of the present invention, reference should be made to the following description in conjunction with the accompanying FIGS. 1-3.

What is claimed is:

1. A surgical guiding sleeves system for orienting multiple drill bits in a single surgical template for making an implant osteotomy, comprising, in one exemplary embodiment, a “thread-lock” system that facilitates the drilling of the osteotomy, accommodating different size holes for different size drills using multiple bushings. The system is based on the use of a master or primary bushing which is inserted into a predetermined hole and secured by means of an adhesive to the pre-custom-made surgical template. Its inner diameter is tapped through 8×32 and reamed out to suit the largest diameter drill being used. The smaller sleeves screw into the primary sleeve and are locked into place. The smaller sleeves are screw-cut to suit the primary bushing and reamed out to suit the subsequent diameter sleeves used.

2. Claim 1, whereas the guiding sleeves system is comprised of multiple bushings with decreasing diameters, inserted into each other.
